(19) United States
(12) Patent Application Publication
(10) Pub. No.: US 2005/0169218 A1
(43) Pub. Date: Aug. 4, 2005

(54) Apparatus and method for data transmission

(76) Inventor: Chi-Yu Ho, Taipei County (TW)

Correspondence Address: BIRCH STEWART KOLASCH & BIRCH, PO BOX 747, FALLS CHURCH, VA, 22040-0747, US

(21) Appl. No.: 10/765,965

(22) Filed: Jan. 29, 2004

(51) Int. Cl. H04Q 7/24

(52) U.S. Cl. 370/338; 370/463

(57) ABSTRACT

An apparatus and method and system for enabling data transmission by a wireless device through a personal computer. A wireless device, comprising a first data link port and a data terminal equipment, and a personal computer, comprising a second Internet access port, a second data link port, and a packet router, are provided. The personal computer connects to the wireless device via a medium, and the personal computer transmits data packets, received from the Internet, through the second Internet access port to the data terminal equipment via the medium using the packet router.

### BACKGROUND OF THE INVENTION

1. Field of the Invention

The present invention relates to an apparatus and method for data transmission, and in particular to an apparatus and method enabling a wireless device to send and receive data through a personal computer.

2. Description of the Related Art

Development of wireless transmission technology has resulted in increased transmission rates for wireless devices. Current wireless technologies, including Bluetooth, personal handy-phone system (PHS), general packet radio service (GPRS), wireless application protocol (WAP), and the like of wireless transmission technologies. Mobile telecommunication and the Internet have gained nearly universal acceptance, however, mobile connectivity is severely limited by slow data transmission rate and high cost.

### SUMMARY OF THE INVENTION

Accordingly, an object of the present invention is to provide a method for enabling a wireless device to transmit and receive data from the Internet, via a medium.

According to the object described above, the present invention provides a method enabling a wireless device to transmit and receive through a personal computer, by the following steps.

A wireless device, comprising a first data link port and a data terminal equipment, and a personal computer, comprising a second Internet access port, a second data link port and a packet router, are first provided. The wireless device is coupled to the personal computer through the first data link port and the second data link port by a medium. The personal computer receives data packets from the Internet through the second Internet access port, and the network data is then transmitted to the data terminal equipment of the wireless device via the medium using the packet router.

The bandwidth provided by a personal computer is larger hence, data transmission is faster, and potentially less costly than wireless data transmission.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the architecture of the apparatus according to the present invention;

FIG. 2 is flowchart showing detailed steps of the method for enabling data transmission by a wireless device through a personal computer according to the present invention.

### DETAILED DESCRIPTION OF THE INVENTION

The invention discloses an apparatus and method for enabling a wireless device to transmit and receive data through a personal computer.

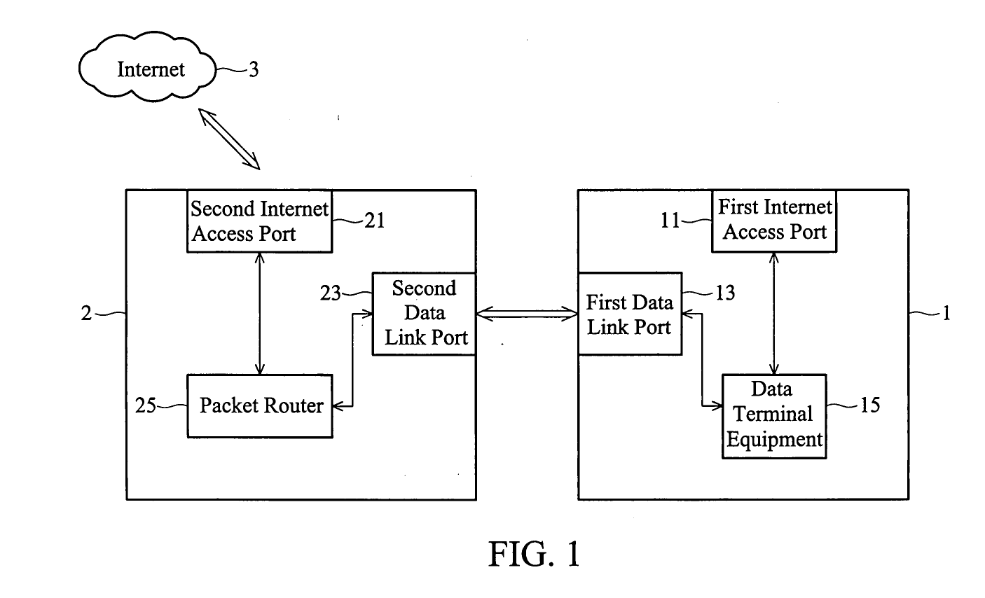

FIG. 1 is a schematic diagram showing the architecture of the apparatus according to the present invention.

The wireless device according this embodiment of the present invention is not limited to the disclosed embodiments.

The architecture comprises a mobile phone 1, having a first Internet access port 11, a first data link port 13 and a data terminal equipment 15, a personal computer 2, having a second Internet access port 21, a second data link port 23, and a packet router, and the Internet 3. The personal computer 2 retrieves data packets from the Internet 3, through Internet access port 21, in which the data packets comprises text, voice, images, and other data. Data packets are delivered to personal computer 2 via Internet access port 21, transmitted through second data link port 23 using packet router 25. A router, as a computer or a device, can bridge different networks or devices, configured for forwarding data packets from one device (or a network) to another. In the embodiment of the present invention, data packets received by personal computer 2 from Internet 3 are packeted to be transmitted through data link port 23, connecting personal computer 2 to other devices using second data link port 23 by way of Bluetooth, RS-232 (recommended standard-232), infrared, Ethernet cables, or the way.

The difference between first Internet access port 11 and second Internet access port 21 is that mobile phone 1 can receive data, complying with mobile telecommunication standards, from wireless networks through first Internet access port 11 using WAP, Bluetooth, GPRS or PHS. Data packets, received from personal computer 2 through first data link port 13, are stored in data terminal equipment 15, which receives and processes data packets to be readable for mobile phone 1.

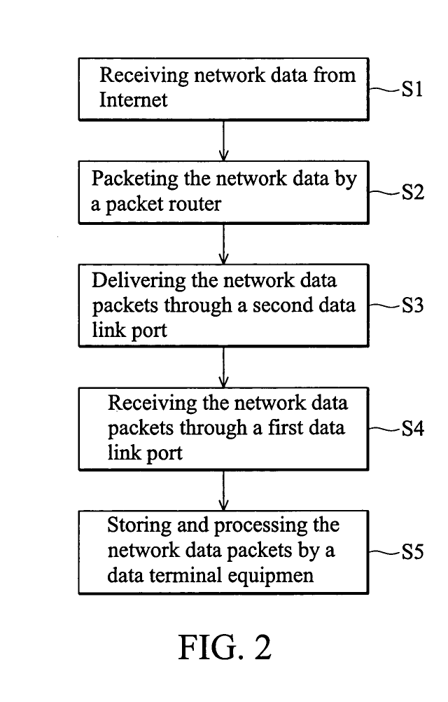

FIG. 2 is flowchart showing detailed steps of the method for enabling a wireless device to transmit and receive data receiving through a personal computer according to the present invention.

In step S1, a personal computer receives desired data packets from the Internet via an Internet access port thereof.

In step S2, a packet router of the personal computer assembles the data packets.

In step S3, the data packets are transmitted through a data link port of the personal computer to a mobile phone.

In step S4, the mobile phone receives the data packets from the personal computer through a data link port thereof.

In step S5, a data terminal equipment of the mobile phone stores and processes network data packets to be readable for the mobile phone.

The apparatus of present invention can rapidly receive data packets from the Internet without incurring high costs from wireless transmission thus, achieving higher bandwidth and lower cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for enabling a wireless device to transmit and receive data receiving through a personal computer, comprising the steps of:
providing a wireless device, comprising a first data link port and a data terminal equipment;
providing a personal computer, comprising a second Internet access port, a second data link port, and a packet router;
coupling the wireless device and the personal computer using the first data link port and the second data link port via a medium;
receiving data packets from the Internet through the second Internet access port; and
transmitting the data packets to the data terminal equipment via the medium using the packet router.

2. The method as claimed in claim 1, wherein in the transmitting step, the network data is delivered from the second data link port to the first data link port via the medium.

3. The method as claimed in claim 2, wherein the medium is Bluetooth, RS-232, USB, or infrared.

4. The method as claimed in claim 1, wherein in the step of providing the wireless device, the wireless device further comprises a first Internet access port for receiving the data packets from the Internet.

5. The method as claimed in claim 1, wherein the wireless device receives data packets from the personal computer via the medium through the first data link port.

6. An apparatus for enabling a wireless device to transmit and receive data receiving through a personal computer, comprising:
a personal computer, coupled to the Internet, comprising a second Internet access port, a second data link port, and a packet router; and
a wireless device, coupled to the personal computer and the Internet, comprising a first data link port and a data terminal equipment, in which the wireless device, using the first data link port, connects to the personal computer, using the second data link port, via a medium, the personal computer receives data packets from the Internet through the second Internet access port, and the data packets is transmitted to the data terminal equipment via the medium using the packet router

7. The apparatus as claimed in claim 6, wherein the network data is delivered from the second data link port to the first data link port via the medium.

8. The apparatus as claimed in claim 7, wherein the medium is Bluetooth, RS-232, USB, or infrared.

9. The apparatus as claimed in claim 6, wherein the wireless device further comprises a first Internet access port for receiving data packets from the Internet.

10. The apparatus as claimed in claim 6, wherein the wireless device receives data packets from the personal computer via the medium using the first data link port.
